(19) United States
(12) Patent Application Publication
(10) Pub. No.: US 2016/0357928 A1
(43) Pub. Date: Dec. 8, 2016

(54) CONTEXTUAL PATIENT SUPPORT

(71) Applicant: HelpAround, Herzliya (IL)

(72) Inventors: Yishai KNOBEL, Tel Aviv (IL); Shlomi AFLALO, Prades Hana-Karkur (IL)

(21) Appl. No.: 15/173,619

(22) Filed: Jun. 4, 2016

Related U.S. Application Data
(60) Provisional application No. 62/172,052, filed on Jun. 6, 2015.

(51) Int. Cl. G06F 19/00; G06F 17/30

(52) U.S. Cl. CPC G06F 19/3418; G06F 17/30864; G06F 17/30312

(57) ABSTRACT

A system for providing continual contextual guidance gathers real time data about a user via a mobile device in the user's possession. The system obtains additional data via at least one database. The system infers a context associated with at least a portion of the real time data and/or the additional data, where the context is associated with the user. The system matches the context to guidance information for the user, where the guidance information is intended to improve a wellbeing associated with the user, and transmits the guidance information back to the user via the mobile device. The system continuously matches the context to guidance information in near real-time for a plurality of users. The system identifies a community of helpers that can assist in improving the wellbeing associated with the user.

### CROSS-REFERENCE TO RELATED APPLICATIONS

This application claims the benefit of priority to U.S. Provisional Patent Application No. 62/172,052, filed Jun. 6, 2015, and entitled “CONTEXTUAL PATIENT SUPPORT”, the entire contents of the application being incorporated herein by reference in its entirety.

### BACKGROUND OF THE INVENTION

Guidance is not a one size fits all solution. Often, the most appropriate guidance is based on a variety of circumstances, including a context surrounding a person or a situation. Context can change from person to person and from moment to moment. Therefore, it would be helpful to have automated real-time, contextual guidance for a user.

### BRIEF SUMMARY OF THE INVENTION

Disclosed herein is a method for providing continual contextual guidance and a corresponding system and a computer program product as specified in the independent claims. Embodiments of the present invention are given in the dependent claims. Embodiments of the present invention can be freely combined with each other if they are not mutually exclusive.

According to an embodiment of the present invention, in a method for providing continual contextual guidance, the method gathers real time data about a user via a mobile device, where the user is in possession of the mobile device. The method obtains additional data via at least one database. The method infers a context associated with at least a portion of the real time data and the additional data, where the context is associated with the user. The method matches the context to guidance information for the user, where the guidance information is intended to improve the wellbeing associated with the user. The method transmits the guidance information back to the user via the mobile device. In an example embodiment, the method continuously matches the context to guidance information in near real-time for a plurality of users.

In an example embodiment, when the method continuously matches the context to guidance information in near real-time, the method applies at least one rule to at least one of the real time data and the additional data to determine new static profile data associated with the user, and/or new existing patterns associated with the user, and/or a current context associated with the user.

In an example embodiment, when the method continuously matches the context to guidance information in near real-time, the method infers the context by executing at least one module. The module is selected for execution based on at least one of the real time data and the additional data.

In an example embodiment, the method identifies a community of helpers that can assist in improving the wellbeing associated with the user.

In an example embodiment, when the method gathers real time data about a user, the method gathers data related to at least one of incoming data points associated with the user, and environmental data. The method determines existing patterns associated with the user by analyzing the incoming data points associated with the user and/or the environmental data. The method stores the existing patterns associated with the user in at least one database.

In an example embodiment, when the method obtains additional data via at least one database, the method obtains the additional data related to a static profile data associated with the user and/or existing patterns associated with the user.

In an example embodiment, when the method matches the context to guidance information for the user, where the guidance information is intended to improve the wellbeing associated with the user, the method matches static profile data associated with the user and existing patterns associated with the user with the context to determine the guidance information.

In an example embodiment, when the method matches the context to guidance information for the user, where the guidance information is intended to improve the wellbeing associated with the user, the method incorporates a result of previous guidance information provided to a plurality of users and their recorded interaction with the provided guidance when matching the context to guidance information for the user.

In an example embodiment, when the method transmits the guidance information back to the user, the method applies a set of rules to determine when to transmit the guidance information back to the user. The method transmits the guidance information to an entity specified by the user. The method may transmit the guidance information to the entity prior to an occurrence of the wellbeing event and/or during the wellbeing event. The method allows the user to determine transmittal details associated with the guidance information transmitted to the entity.

In an example embodiment, when the method transmits the guidance information back to the user via the mobile device, the method tracks the user's response to the guidance information. The method identifies the user's response as new existing patterns associated with the user.

In an example embodiment, when the method the transmits the guidance information back to the user via the mobile device, the method allows an entity to track at least one of the real time data and the additional data. The method also allows the entity to activate transmission of the guidance information to at least one of the user and at least one other entity.

### BRIEF DESCRIPTION OF THE SEVERAL VIEWS OF THE FIGURES

FIG. 1 illustrates an embodiment of a system for providing continual contextual guidance, according to embodiments disclosed herein.

FIG. 2 is a flowchart illustrating an embodiment of a method for providing continual contextual guidance, according to embodiments disclosed herein.

FIGS. 3 through 14 illustrate example screen shots of an embodiment of a method for providing continual contextual guidance, according to embodiments disclosed herein.

### DETAILED DESCRIPTION OF THE INVENTION

The present invention provides continual contextual guidance. The following description is presented to enable one of ordinary skill in the art to make and use the present invention and is provided in the context of a patent application and its requirements. Various modifications to the embodiment will be readily apparent to those skilled in the art and the generic principles herein may be applied to other embodiments. Thus, the present invention is not intended to be limited to the embodiment shown but is to be accorded the widest scope consistent with the principles and features described herein.

Reference in this specification to “one embodiment”, “an embodiment”, “an exemplary embodiment”, or “a preferred embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments. In general, features described in one embodiment might be suitable for use in other embodiments as would be apparent to those skilled in the art.

The present invention can take the form of an entirely hardware embodiment, an entirely software embodiment or an embodiment containing both hardware and software elements. In a preferred embodiment, the present invention is implemented in software, which includes but is not limited to firmware, resident software, microcode, etc.

Furthermore, the present invention can take the form of a computer program product accessible from a computer usable or computer readable storage medium providing program code for use by or in connection with a computer or any instruction execution system. For the purposes of this description, a computer usable or computer readable storage medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, point devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified local function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

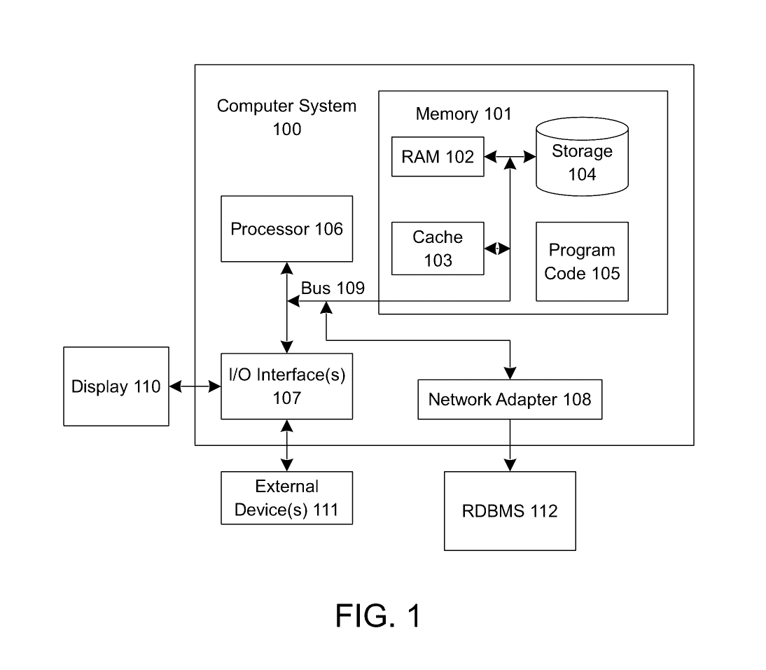

FIG. 1 illustrates a system for providing continual contextual guidance according to embodiments of the present invention. The computer system 100 is operationally coupled to a processor or processing units 106, a memory 101, and a bus 109 that couples various system components, including the memory 101 to the processor 106. The bus 109 represents one or more of any of several types of bus structure, including a memory bus or memory controller, a peripheral bus, an accelerated graphics port, and a processor or local bus using any of a variety of bus architectures. The memory 101 may include computer readable media in the form of volatile memory, such as random access memory (RAM) 102 or cache memory 103, or non-volatile storage media 104. The memory 101 may include at least one program product having a set of at least one program code module 105 that are configured to carry out the functions of embodiment of the present invention when executed by the processor 106. The computer system 100 may also communicate with one or more external devices 111, such as a display 110, via I/O interfaces 107. The computer system 100 may communicate with one or more networks via network adapter 108. The computer system 100 may communicate with one or more databases 112 via network adapter 108.

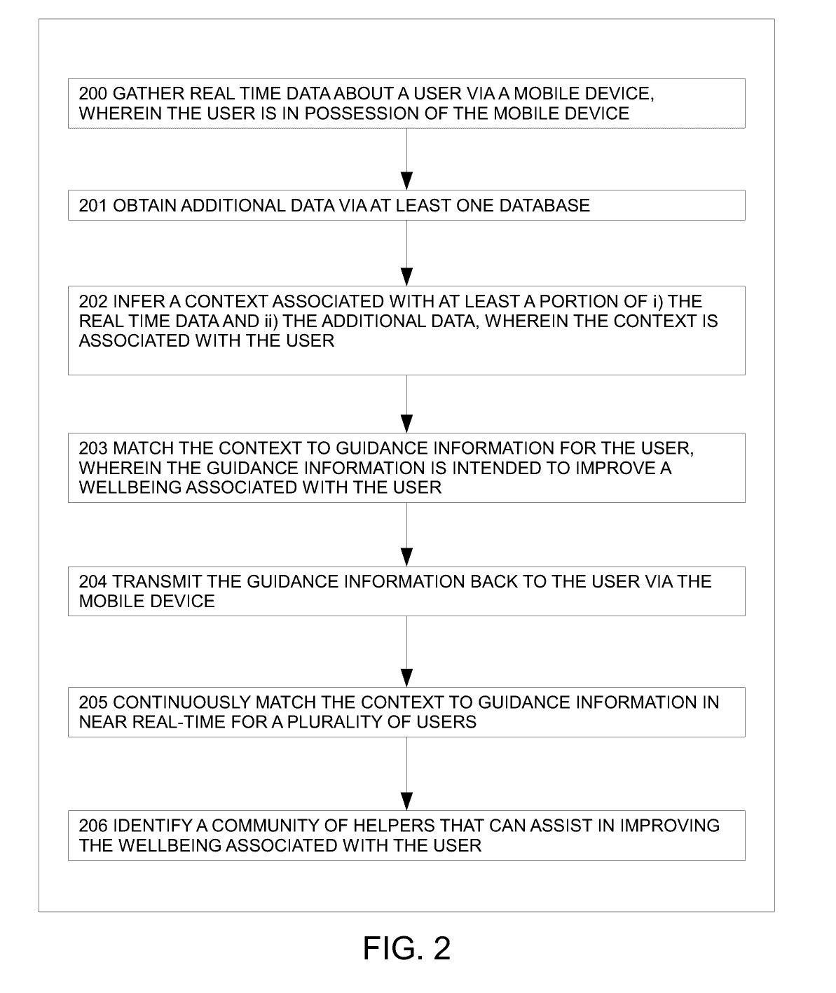

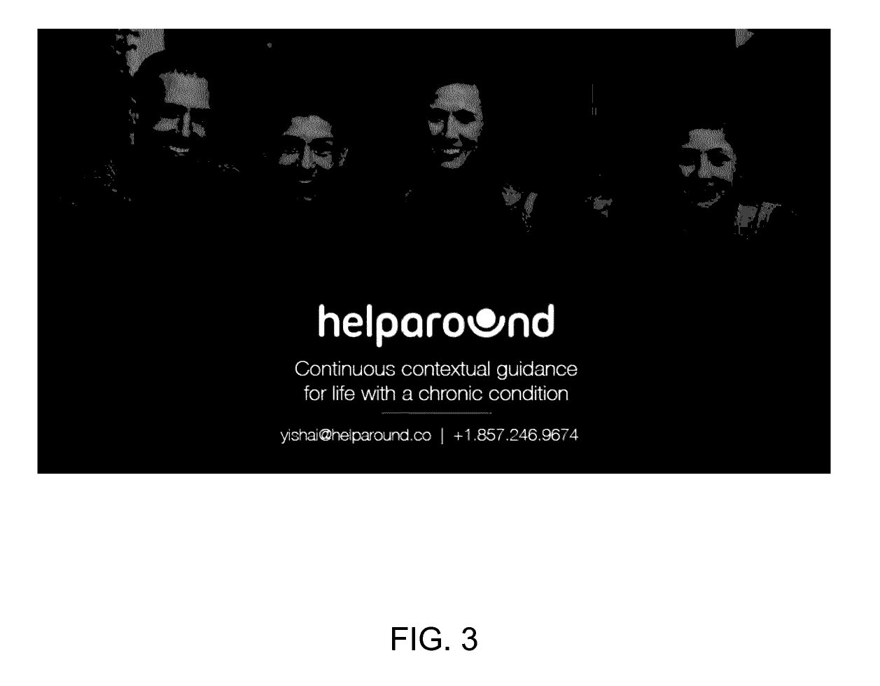

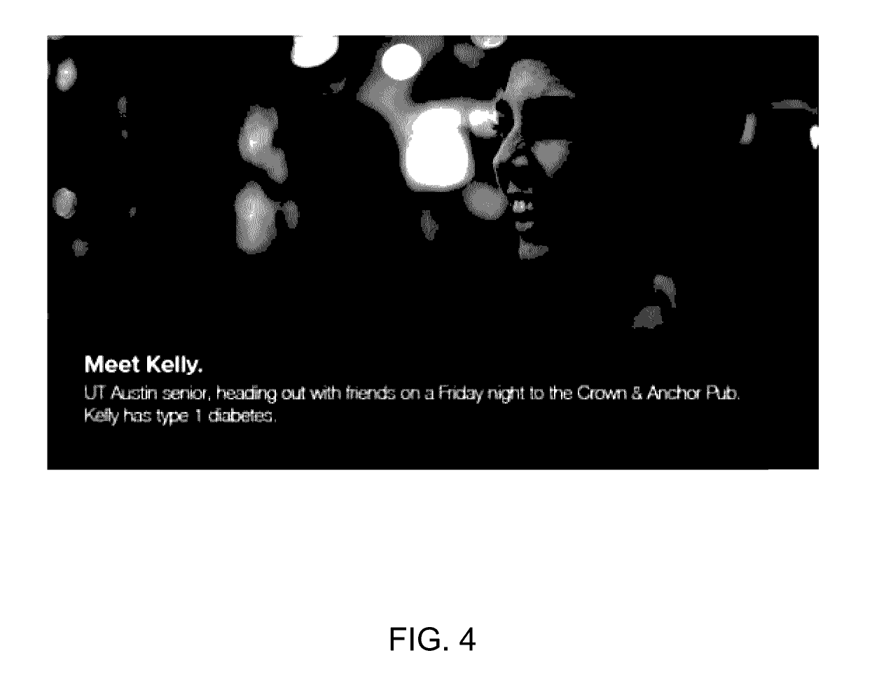

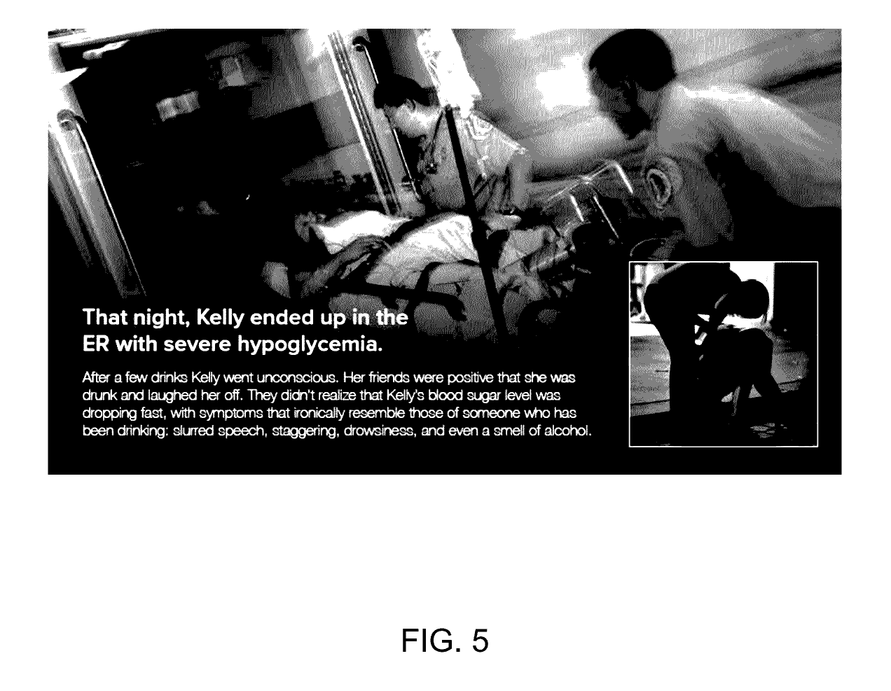

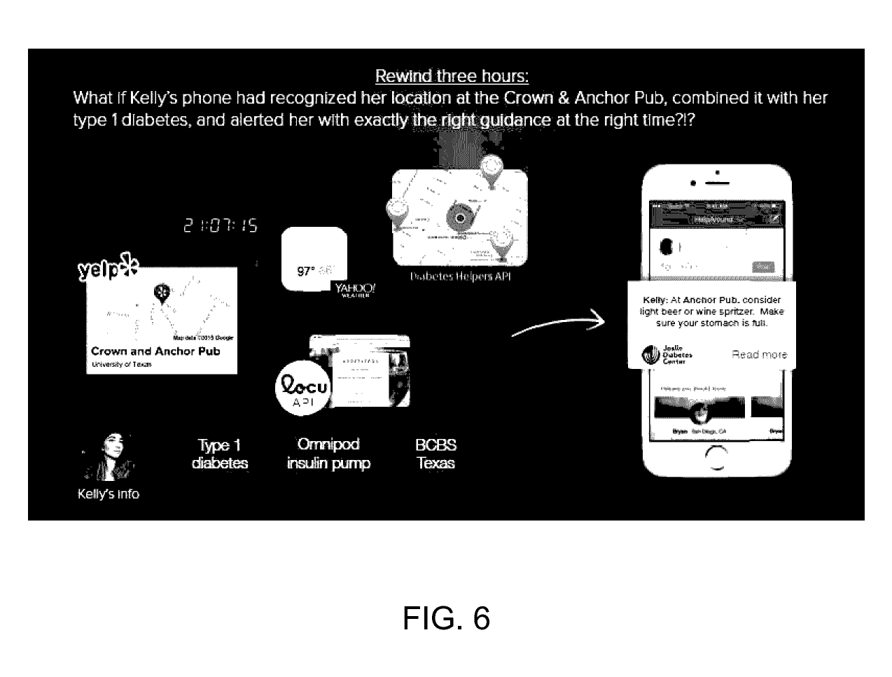

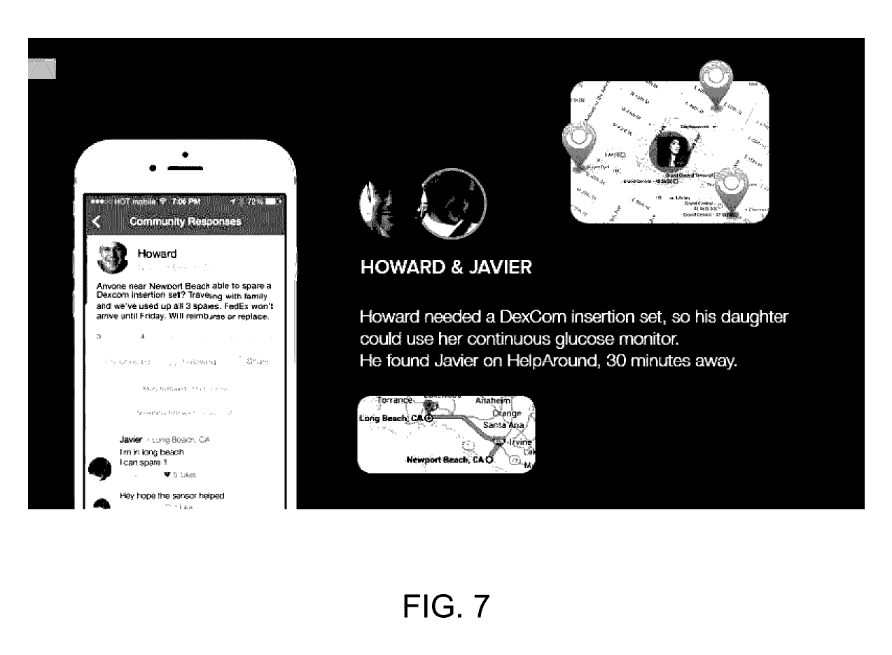

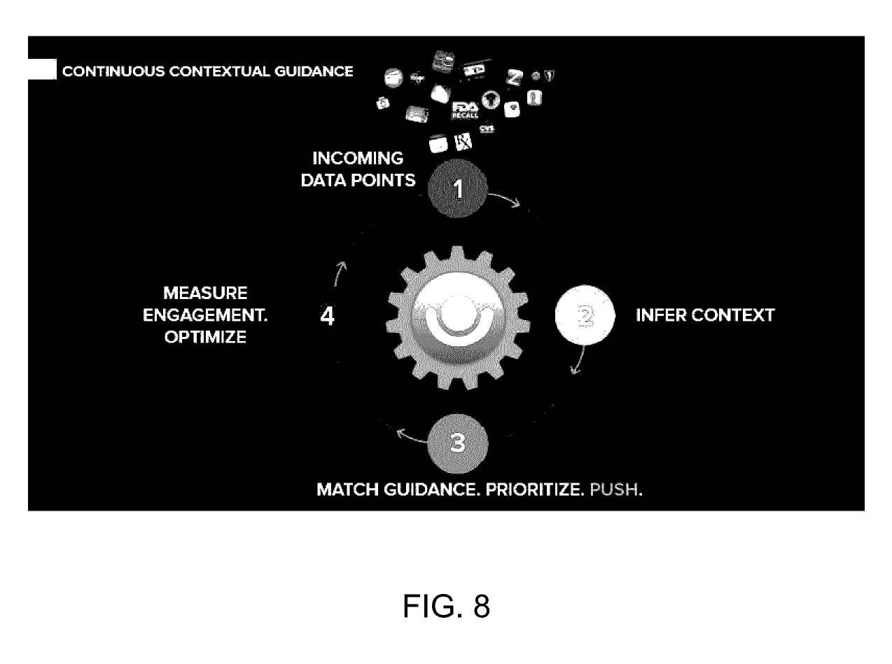

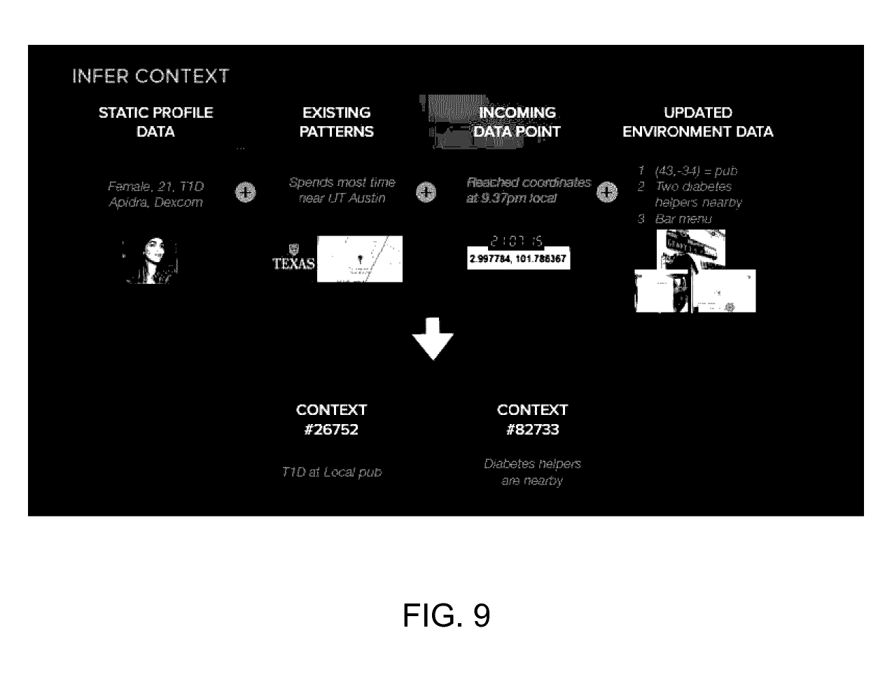

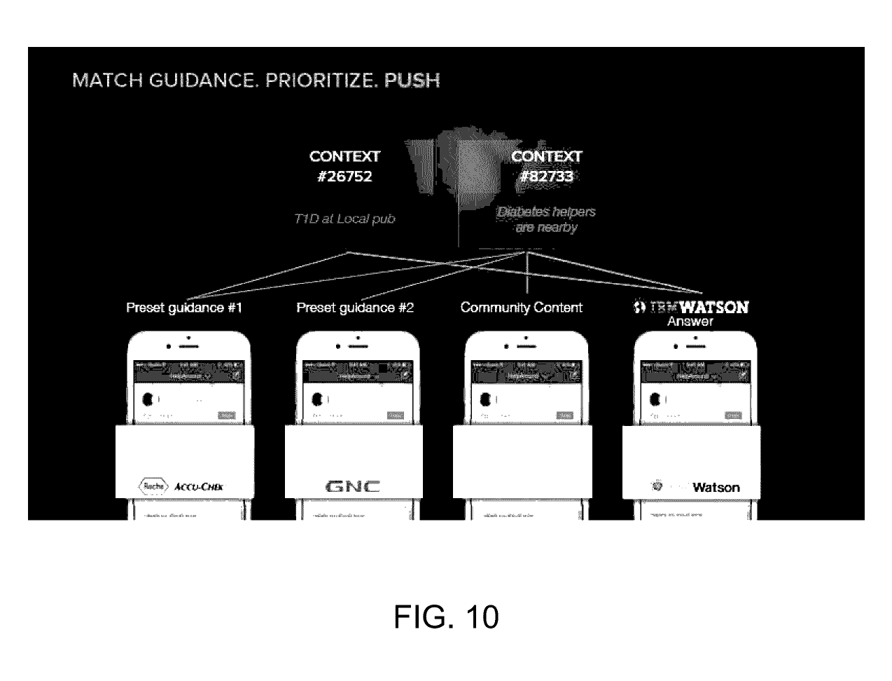

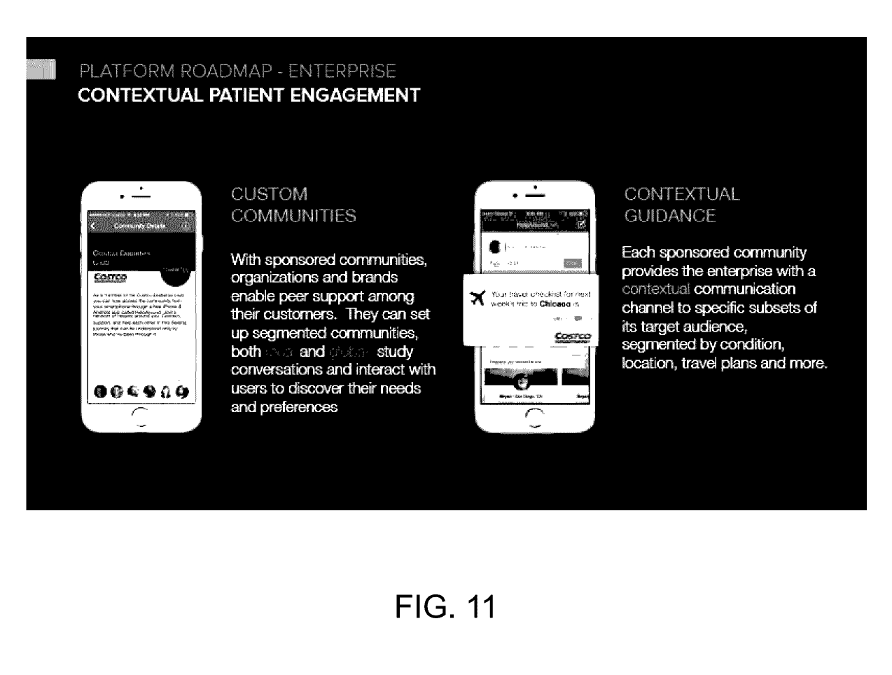

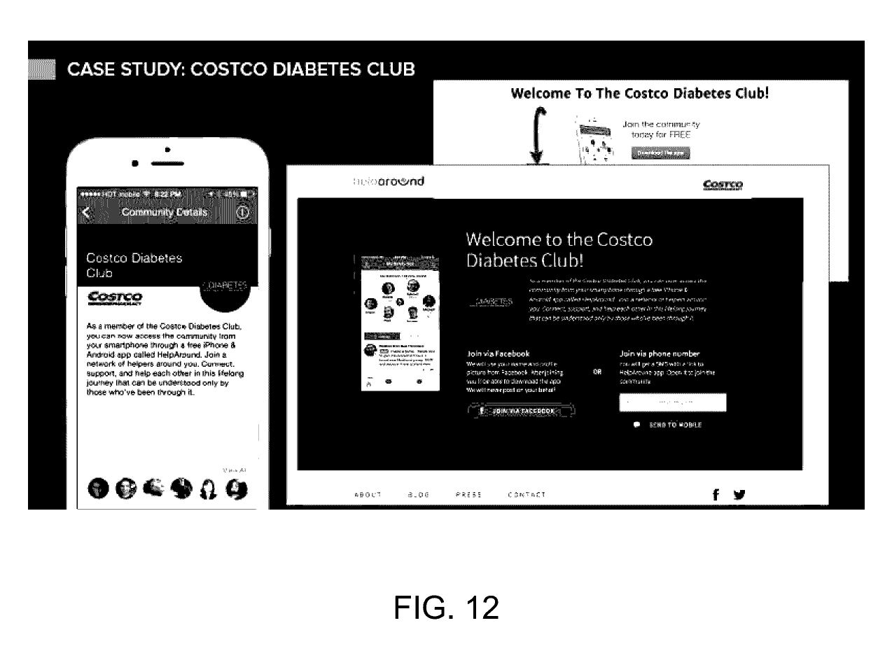

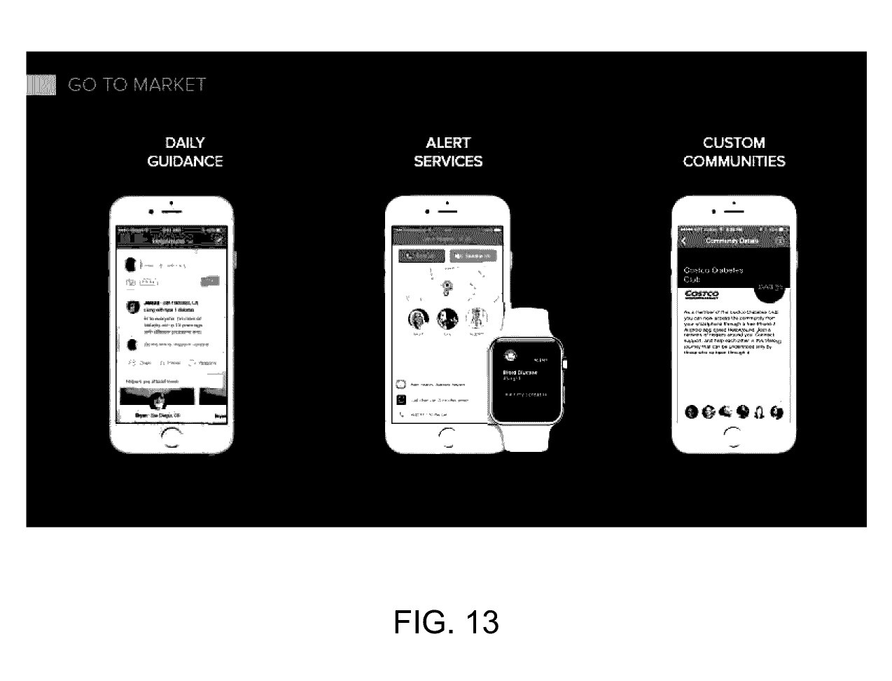

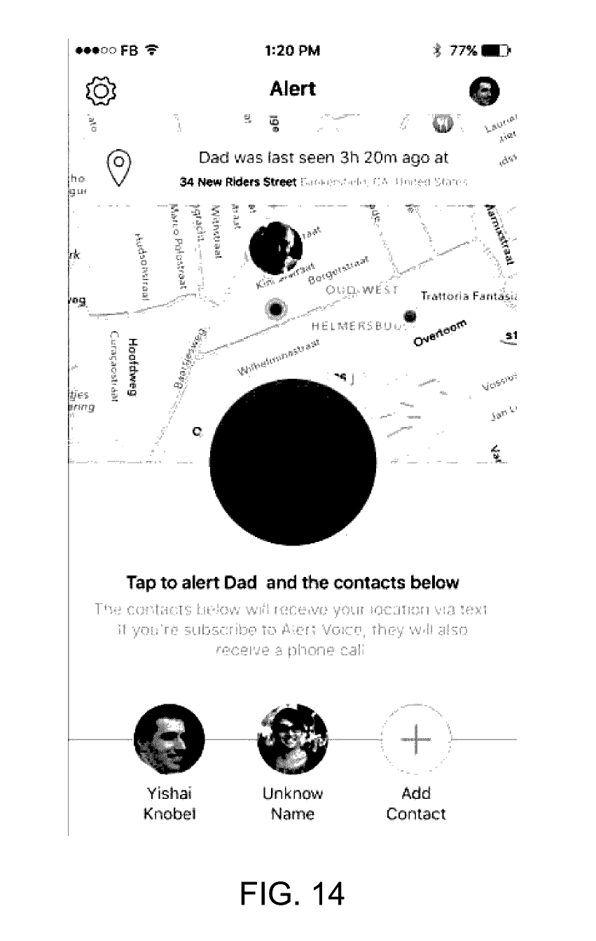

FIG. 2 illustrates an embodiment of a method for providing continual contextual guidance. At 200, the method gathers real time data about a user via a mobile device, where the user is in possession of the mobile device. For example, the method may obtain information, such as the user's location, from the user's mobile device that the user carries.

At 201, the method obtains additional data via at least one database. In an example embodiment, the database may be an online database, or a local database, such as a database that exists on the user's mobile device. The additional data may include, for example, the user's past location data, the user's personal data, such as health issues, etc. For example, the method may determine that the user has spent the last 4 hours at a library, and prior to that, the user had been at a local restaurant 6 hours ago. The method may also determine that the user has Type 1 Diabetes, uses a particular type of insulin pump, and also what medical insurance plan the user has.

At 202, the method infers a context associated with at least a portion of the real time data and/or the additional data, where the context is associated with the user. For example, the method may determine that the user is currently at a local bar, and hasn't visited a restaurant in 6 hours. The method may determine that the user has spent the past 4 hours at a library (and, therefore, might not have been able to eat while at the library). The method may also determine that the user has Type 1 Diabetes and wears an insulin pump. The method infers a context from the above information. For example, the method may infer that the user has not eaten in 6 hours, and is in a bar where the user might order an alcoholic drink. In another example embodiment, the method may infer that the user is inclined to order an alcoholic drink based on existing patterns the method has collected from the user's past behavior. The method may also infer existing patterns from a plurality of users. At 203, the method matches the context to guidance information for the user, where the guidance information is intended to improve a wellbeing associated with the user, or to prevent an unwanted wellbeing or health event from occurring. In an example embodiment, the method matches the context (i.e., diabetic, hasn't eaten in 6 hours, currently located in a bar) with guidance information that is specific to the user, and the context. For example, the method may match the context to guidance information, such as, “Kelly: At Anchor Pub. Consider drinking light beer, or a wine spritzer. Make sure your stomach is full”. Here, the method provides guidance information intended to improve Kelly's wellbeing by insuring that she does not consume alcohol on an empty stomach, and that she eats to maintain an even blood sugar level. The method provides guidance information also to prevent an unwanted health event from occurring, such as an episode of severe hypoglycemia that might be misinterpreted by Kelly's friends as simply being the result of too much alcohol, and where her friends might not be aware that they need to get Kelly medical help immediately. The guidance information may be pre-loaded guidance information. The guidance information may include information related to the nearest pharmacy that takes the user's health insurance plan. In this scenario, the method would obtain the user's health information (for example, that the user is a diabetic along with the user's health insurance plan information) from the static profile data and the updated environmental data (for example, at a conference in New Orleans) to determine the nearest pharmacy that takes the user's health insurance plan.

The method may also provide guidance information in the form of a community of helpers. The community of helpers may be, for example, medically trained people, people who have volunteered to help a fellow diabetic in need, etc. Thus, the guidance information transmitted to the user's mobile phone may indicate that there are helpers nearby who have been notified that the user may need assistance. The guidance information may also be provided by entities that are associated with the context inferred by the method. For example, the method infers a context that a diabetic user has not tested his/her blood sugar level in several hours. The manufacturer of the glucose monitor used by the diabetic user may provide guidance information related to how frequently the diabetic user should test his/her blood sugar level. In this scenario, once the method has inferred that the diabetic user may need to test his/her blood sugar level, the method may determine the glucose monitor used by the diabetic user (from the database containing the static profile data), retrieve guidance information from a database associated with the manufacturer of the glucose monitor, and then transmit that guidance information to the diabetic user. The guidance information may also include an automatically generated description of the user's activity prior to the guidance information being sent. For example, the user may have been driving right before the guidance information was sent.

At 204, the method transmits the guidance information back to the user via the user's mobile device. For example, the diabetic user, who last ate 6 hours ago, spent the last 4 hours in a library, and has arrived at a local bar, receives a text message on their mobile phone advising the user to drink only light alcohol drinks, and to eat something along with the alcoholic beverages.

At 205, the method continuously matches the context to guidance information in near real-time for a plurality of users. In an example embodiment, the method performs the steps of obtaining additional data, inferring a context, and matching the context to guidance information for the user continuously in near real time, and does so for a plurality of users. New data points are constantly streamed from client devices (i.e., mobile phones, web applications, other systems, etc.) to a set of servers. The new data points and the guidance information are sent in as near to real time as possible. The servers receive the data points, parse the data and then convert the data into a standard format.

At 206, the method identifies a community of helpers who can assist in improving the wellbeing associated with the user. For example, the community of helpers may include, but is not limited to, other individuals such as patients, caregivers, professionals who are associated with the user, professionals who are not associated with the user, etc. The community of helpers may assist in improving the wellbeing associated with the user, and/or may also remedy an event after it happened. For example, the community of users may provide a needed item, such as diabetic test strips, to a diabetic user so that the user may test his/her blood sugar at the appropriate time. The community of users may also help the diabetic user remedy an event if, for example, the diabetic user's blood sugar is too low, and the diabetic user begins to feel shaky and sweaty. In this scenario, the community of users may remedy the event by, for example, providing glucose tablets, or other sugary food, to elevate the diabetic user's low blood sugar. In doing so, the community of users may prevent a more serious event, such as the diabetic user losing consciousness, from happening.

In an example embodiment, when the method continuously matching the context to guidance information in near real-time, the method applies at least one rule to at least one of i) the real time data and ii) the additional data to determine at least one of i) new static profile data associated with the user, ii) new existing patterns associated with the user, and iii) a current context associated with the user. Based on the incoming real time data and the additional data (for example, real time data associated with the user), the method retrieves relevant historical data from at least one database, and determines which rule(s) apply (and which modules to execute) to the incoming real time data and the additional data. The result of running the rules may be new static data points, such as the user's gender, details about the user's work and/or school, health details associated with the user, etc. The result may be new behavior patterns identified and associated with the user, such as a location where the user works and/or attends school, the applications on the user's mobile device that the user interacts with most frequently, etc. The result may also be a current context associated with the user, such as the user's current location.

In an example embodiment, when the method continuously matches the context to guidance information in near real-time, the method infers the context by executing at least one module. The module is selected for execution based on at least one of i) the real time data and ii) the additional data. As noted above, the rules and modules are applied to the incoming real time data and the additional data. In an example embodiment, the rules and modules chosen to be executed are executed in parallel, for example, on one or more machines such that the method is faster and scalable. Over time, more rules and modules are added to improve accuracy and identify/infer additional contexts. Each module may use a different algorithm to scan parts of the historical data (stored for the user and/or a plurality of users), and/or external data sources to infer context(s) for the user and/or a plurality of users.

In an example embodiment, when the method gathers real time data about a user, the method gathers data related to incoming data points associated with the user, and/or environmental data. For example, the method may gather details such as how recently the user accessed an application on their mobile device related to blood sugar testing, and the user's current location. In an example embodiment, the method may determine existing patterns associated with the user by analyzing the incoming data points associated with the user, and/or the environmental data. The method then stores the existing patterns associated with the user in at least one database.

In an example embodiment, when the method obtains additional data via at least one database, the method obtains the additional data related to the static profile data associated with the user and/or existing patterns associated with the user. For example, when the user arrives at the bar, the method obtains the real time data related to the user via the user's mobile device (such as the user's current location at the bar), and obtains additional data (such as the fact that the user is a diabetic) from at least one database.

In an example embodiment, when the method matches the context to guidance information for the user, where the guidance is intended to improve the wellbeing associated with the user, the method matches static profile data associated with the user and existing patterns associated with the user with the context to determine the guidance information. For example, the method may determine that the user is a diabetic who tends to frequent establishments near a university campus. For example, the method may determine that the user is a diabetic based on information within the static profile associated with the user. The method may then determine that the user may be a college student and may present the guidance information in a way that has been positively received by college age users in the past.

In an example embodiment, when the method matches the context to guidance information for the user, where the guidance information is intended to improve the wellbeing associated with the user, the method incorporates a result of previous guidance information provided to a plurality of users when matching the context to guidance information for the user. As noted above, the method may incorporate the results of previous guidance information provided to multiple users when matching the guidance information (that's most appropriate for the user) to the user.

In an example embodiment, when the method transmits the guidance information back to the user, the method applies a set of guidance rules to the guidance information to determine when to transmit the guidance information back to the user. The method may apply a set of guidance rules to the guidance information to determine whether to send the guidance information to the user, when to send the guidance information, etc. The method may also transmit the guidance information to an entity specified by the user. The entity may be another person, multiple people and/or an organization. The user may specify the entity either in advance of the method transmitting the guidance information, and/or when the method is transmitting the guidance information. In addition, the method may transmit the guidance information to the entity prior to an occurrence of the wellbeing event and/or during the occurrence of the wellbeing event. In an example embodiment, the method allows the user to determine transmittal details associated with the guidance information transmitted to the entity, for example when and how the guidance information is transmitted to the entity (that the user specified).

In another example embodiment, when the method the transmits the guidance information back to the user via the mobile device, the method allows an entity to track at least one of the real time data and the additional data. For example, the method may allow a caregiver to track the user's location, and/or the user's last blood sugar levels. The method also allows the entity to activate transmission of the guidance information to at least one of the user and at least one other entity. For example, if the caregiver cannot track the location of the user (i.e., “Dad is not responding, and his blood sugar is low”), the caregiver may activate guidance information (or in this case, an alert) to other entities, such as police, or other caregivers. In this scenario, the guidance information/alert may be a conference call (initiated from what appears to be the user's cell phone so that the caregivers think the loved one is calling) that alerts the user's emergency contacts that help is needed.

In an example embodiment, the method interfaces with at least one database containing a plurality of content types to be transmitted to the user as guidance information. Each content type is comprised of a content template, qualification rules, and distribution rules. Additional content types may be added into the databases as the method continuously infers context, transmits guidance information and receives a response to the guidance information (even if the user provides no response at all). The content template is a template where variables related the current applicable user and the inferred context are merged to create the guidance information to transmit to the user. The variables may comprise the user name, location names, date/time data. For example: “Hey <firstName>, going for drinks at <bar name>? Consider drinking light beer or wine spritzer and make sure your stomach is full.” For example, the method may use this template when a user with diabetes enters a location that serves alcohol. The qualification rules are rules that allow the method to determine whether to transmit the guidance information to the user. The rules may be based on frequency (how many times that user already saw the guidance information, how recent the user saw that the guidance information, the time of the day, location, and/or which contexts were inferred in the current event. The method processes the qualification rules resulting in a qualification score. In the case of multiple content types matching, the system may choose to transmit to the user the guidance information (or several different guidance information messages) that has the highest qualification score. The distribution rules determine how the guidance information should be transmitted to the user (i.e., as a private message from a virtual user, as a loud push notification, appearing as the top content in the app, the length of time that the guidance information is displayed on the user's mobile device, etc.). The method matches each of the relevant content types existing in to the matched guidance information, and calculates the qualification score for the content types. The method will transmit, according to the distribution rules, the matching guidance information that scored the highest qualification scores.

In an example embodiment, when the method transmits the guidance information back to the user via the mobile device, the method tracks the user's response to the guidance information. For example, the method may receive a reply from the user in response to receiving the guidance information (or the user may ignore the guidance information, and the method interprets the lack of response as a response). The user may perform an action, such as accessing an application on the mobile device, for example, related to checking the user's blood sugar. The method infers from this action that the user has responded positively to the guidance information transmitted to the user. The method receives the user's response, and identifies the user's response as a new existing patterns associated with the user.

In an example embodiment, the method collects logs of activity and usage data. For example, how the users reacted to the guidance information, which guidance information received the least/most reactions, in which contexts did the guidance information receive the least/most reactions, which rules were running to identify the context, which data collected was used when inferring the context and matching the guidance information, etc. The method analyzes the data and uses that data to generate new rules, and to optimize the existing rules and modules. The method uses the new data and/or the optimized rules and modules to identify more types of contexts, to utilize more raw data, and to match more relevant guidance information to transmitted to the users.

A method and system for providing continual contextual guidance have been disclosed.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method of providing continual contextual guidance, the method comprising:
gathering real time data about a user via a mobile device, wherein the user is in possession of the mobile device;
obtaining additional data via at least one database;
inferring a context associated with at least a portion of i) the real time data and ii) the additional data, wherein the context is associated with the user;
matching the context to guidance information for the user, wherein the guidance information is intended to improve a wellbeing associated with the user; and
transmitting the guidance information back to the user via the mobile device.

2. The method of claim 1 further comprising:
continuously matching the context to guidance information in near real-time for a plurality of users.

3. The method of claim 2 wherein continuously matching the context to guidance information in near real-time comprises:
applying at least one rule to at least one of i) the real time data and ii) the additional data to determine at least one of:
i) new static profile data associated with the user;
ii) new existing patterns associated with the user; and
iii) a current context associated with the user.

4. The method of claim 2 wherein continuously matching the context to guidance information in near real-time comprises:
inferring the context by executing at least one module, wherein the at least one module is selected for execution based on at least one of i) the real time data and ii) the additional data.

5. The method of claim 1 further comprising:
identifying a community of helpers that can assist in improving the wellbeing associated with the user.

6. The method of claim 1 wherein gathering real time data about a user comprises:
gathering data related to at least one of:
i) incoming data points associated with the user; and
ii) environmental data.

7. The method of claim 6 further comprising:
determining existing patterns associated with the user by analyzing at least one of:
i) the incoming data points associated with the user; and
ii) the environmental data; and
storing the existing patterns associated with the user in the at least one database.

8. The method of claim 1 wherein obtaining additional data via the at least one database comprises:
obtaining the additional data related to at least one of:
i) a static profile data associated with the user; and
ii) existing patterns associated with the user.

9. The method of claim 1 wherein matching the context to guidance information for the user, the guidance information intended to improve the wellbeing associated with the user comprises:
matching static profile data associated with the user and existing patterns associated with the user with the context to determine the guidance information.

10. The method of claim 1 wherein matching the context to guidance information for the user, the guidance information intended to improve the wellbeing associated with the user comprises: incorporating a result of previous guidance information provided to a plurality of users when matching the context to guidance information for the user.

11. The method of claim 1 wherein transmitting the guidance information back to the user comprising:
applying a set of guidance rules to the guidance information to determine when to transmit the guidance information back to the user.

12. The method of claim 11 further comprising:
transmitting the guidance information to an entity specified by the user.

13. The method of claim 12 further comprising:
transmitting the guidance information to the entity at least one of:
i) prior to an occurrence of the wellbeing event; and
ii) during the occurrence of the wellbeing event.

14. The method of claim 11 further comprising:
allowing the user to determine transmittal details associated with the guidance information transmitted to the entity specified by the user.

15. The method of claim 1 wherein transmitting the guidance information back to the user via the mobile device comprises:
tracking the user's response to the guidance information.

16. The method of claim 15 further comprising:
identifying the user's response as new existing patterns associated with the user.

17. The method of claim 1 wherein transmitting the guidance information back to the user via the mobile device comprises:
allowing an entity to track at least one of the real time data and the additional data; and allowing the entity to activate transmission of the guidance information to at least one of the user and at least one other entity.

18. A computer program product for providing continual contextual guidance, the computer program product comprising:
a computer readable storage medium having computer readable program code embodied therewith, the program code executable by a computing processor to:
obtain additional data via at least one database;
infer a context associated with at least a portion of i) the real time data and ii) the additional data, wherein the context is associated with the user;
match the context to guidance information for the user, wherein the guidance information is intended to improve a wellbeing associated with the user; and
transmit the guidance information back to the user via the mobile device.

19. The computer program product of claim 17 further configured to:
continuously match the context to guidance information in near real-time for a plurality of users.

20. A system comprising:
a computing processor; and
a computer readable storage medium operationally coupled to the processor, the computer readable storage medium having computer readable program code embodied therewith to be executed by the computing processor, the computer readable program code configured to:
obtain additional data via at least one database;
infer a context associated with at least a portion of i) the real time data and ii) the additional data, wherein the context is associated with the user;
match the context to guidance information for the user, wherein the guidance information is intended to improve a wellbeing associated with the user; and
transmit the guidance information back to the user via the mobile device.
